(19) United States
(12) Patent Application Publication
(10) Pub. No.: US 2016/0036326 A1
(43) Pub. Date: Feb. 4, 2016

(54) POWER SUPPLY CONTROL AND CURRENT EMULATION

(71) Applicant: International Rectifier Corporation, El Segundo, CA (US)

(72) Inventor: Venkat Sreenivas, Winchester, MA (US)

(21) Appl. No.: 14/547,326

(22) Filed: Nov. 19, 2014

Related U.S. Application Data
(60) Provisional application No. 62/030,307, filed on Jul. 29, 2014.

(51) Int. Cl. H02M 3/158

(52) U.S. Cl. CPC H02M 3/158

(57) ABSTRACT

According to example configurations herein, a power supply control circuit includes an emulator circuit. The emulator circuit includes: i) a first input to receive a first input value, the first input value indicating a magnitude of an input voltage used by a power supply circuit to produce an output voltage to power a respective load, and ii) a second input to receive a second input value, the second input value indicating a magnitude of the output voltage produced by the power supply circuit. The current emulator circuit uses the magnitude of the input voltage and the magnitude of the output voltage to emulate current flowing through the inductor of the power supply circuit. The emulated current flow represents an actual current supplied by the inductor to the load. The power supply control circuit uses the emulated current flowing through the inductor to control the magnitude of the output voltage within a desired range.

### RELATED APPLICATIONS

This application is related to and claims the benefit of earlier filed U.S. Provisional Patent Application Ser. No. 62/030,307 entitled “Emulated Peak Current Mode Control Scheme,” Attorney Docket No. CHL14-01(IR-2014-04-28a)p, filed on Jul. 29, 2014, the entire teachings of which are incorporated herein by this reference.

### BACKGROUND

As is well known, conventional multi-phase voltage regulators typically control activation and deactivation of respective control and synchronous switches in a power supply phase to produce an output voltage to power a respective load.

Certain types of voltage regulators, such as those that operate in a current control mode, physically measure an amount of current through a respective inductor of a power supply to control a respective output voltage within a desired range. In general, power supplies that operate in accordance with a current control mode measure an error voltage as well measure an actual current through the phase inductor.

In accordance with a conventional current mode control, when the output voltage of the phase sags below a desired set point due to a transient increase in current consumption, the current mode control circuit supplies more current to the load to account for the increased load. Conversely, when the output voltage rises above the set point due to a transient decrease in current consumption, the current mode control circuit supplies less current to the load. These current mode control responses ensure that the output voltage of the power supply circuit operates within a desired output voltage range.

### BRIEF DESCRIPTION

Implementing a switching power supply in accordance with a conventional current control mode offers advantages such as a simpler feedback loop and Vin (input voltage) disturbance rejection. However, conventional voltage regulators operated in such manner typically suffer from relatively slower transient response and transient recovery.

For example, as mentioned, conventional current control mode includes physically measuring an amount of current through a respective inductor using a complex current detection circuit. In addition to being complex, such circuits are typically slow to detect actual current flow, especially when implemented in a digital manner. The delay associated with physically measuring current through the inductor results in a slow transient response. Accordingly, it is difficult for conventional power supplies operating in a current control mode to quickly accommodate transient conditions in which a respective load instantaneously consumes more or less current. Also, when physically measuring inductor current, the signal can be noisy which leads to inaccurate control.

In contrast to conventional current control mode techniques, embodiments herein include a power supply including an emulator circuit. The object of the emulator circuit is to recreate the inductor current without the noise and without the delay. The emulator circuit includes: i) a first input to receive a first input value indicating a magnitude of an input voltage (Vin) used by a power supply circuit to produce an output voltage (Vout) to power a respective load, ii) a second input to receive a second input value indicating a magnitude of the output voltage produced by the power supply circuit. During operation, the current emulator circuit uses the magnitude of the input voltage and the magnitude of the output voltage to emulate an actual amount of current flowing through an inductor of the switching power supply circuit. The emulated current flow is an estimate of the actual current flow.

In accordance with further embodiments, the emulator circuit outputs the emulated current flow based on its inputs (input voltage, output voltage, pwm pulse train). In such an embodiment, the outputted emulated current computationally tracks changes in the actual current supplied by the inductor to the load based upon the input voltage and the output voltage.

A power supply circuit (such as a DC-to-DC converter circuit) as further described herein can include a control switch and a synchronous switch electrically coupled to an input node of the inductor. An output node of the inductor produces the output voltage that supplies power to a respective load. The power supply circuit includes a control circuit configured to receive the emulated current produced by the current emulator circuit. The control circuit utilizes the emulated current to control the state of the control switch and the synchronous switch in the power supply circuit to produce the output voltage within a desired range.

In accordance with still further embodiments, in addition to receiving the varying signal representing current through the inductor, the control circuit receives a feedback signal. In one embodiment, the feedback signal is generated based on comparison of the magnitude of the output voltage to a reference voltage. If desired, the feedback signal can be compensated based on any of one or more power supply parameters.

The control circuit compares the emulated current produced by a current emulator circuit to the feedback signal to generate a respective pulse width modulation signal that controls the control switch and the synchronous switch in the switching power supply.

In one embodiment, the emulated current flow represents an actual current such as an AC (Alternating Current) portion of the actual current supplied by the inductor to the load. Alternatively, if desired, the emulated current flow can represent both an AC portion and a DC (Direct Current) portion of the actual current supplied by the inductor to the load.

In accordance with further embodiments, the current emulator circuit includes a buffer (such as a multi-bit register) and arithmetic processing hardware (such as computer processor hardware). The arithmetic processing hardware stores a value in the buffer representing the emulated current flow. During operation, the arithmetic processing hardware increments the value stored in the buffer during a first portion of a power supply switching cycle when a control switch of the power supply phase is activated to connect the input voltage to the inductor. The arithmetic processing hardware decrements the value stored in the buffer during the second portion of the switching cycle when only the synchronous switch circuit is activated. The current emulator circuit utilizes the value in the buffer to produce an output signal representative of the current flow.

In yet further embodiments, the emulator circuit further includes an additional input to receive a pulse width modulation control signal used to control activation of the first switch circuit and the second switch circuit during the switching cycle. For example, the emulator circuit uses the pulse width modulation control signal to identify when to increment the value in the buffer and went to decrement the value in the buffer.

If desired, the arithmetic processor hardware can be configured to apply a bias to a magnitude of the value in the buffer to prevent errors from accumulating. This can be achieved by incrementing or decrementing the value in the buffer towards a predetermined current value such as 0 A (indicating that the current through the inductor is 0 Amperes).

Any combination of one or more technical features as discussed herein can be used to produce an improved voltage regulator circuit capable of providing better transient response than conventional voltage regulators.

These and other more specific embodiments are disclosed in more detail below.

The embodiments as described herein are advantageous over conventional techniques. For example, the embodiments as discussed herein are applicable to switching voltage regulators with a buck topology for application to low voltage processors, memory, digital ASICs, etc. The concepts disclosed herein, however, are applicable to other suitable topologies such as boost regulators, buck-boost regulators, etc. Implementation of embodiments herein in a current mode control environment provide better transient response than conventional techniques. Furthermore, they allow for current mode control without the expense of measuring the phase currents. This measurement gets expensive for digital measurement of currents for multi phase systems.

Note that embodiments herein can include a controller/emulator configuration of one or more processor devices to carry out and/or support any or all of the method operations disclosed herein. In other words, one or more computerized devices or processors can be programmed and/or configured to operate as explained herein to carry out different embodiments.

Yet other embodiments herein include software programs to perform the steps and operations summarized above and disclosed in detail below. One such embodiment comprises a computer program product that has a non-transitory computer-storage medium (e.g., memory, disk, flash, . . . ) including computer program logic encoded thereon that, when performed in a computerized device having a processor and corresponding memory, programs the processor to perform the operations disclosed herein. Such arrangements are typically provided as software, code and/or other data (e.g., data structures) arranged or encoded on a computer readable storage medium or non-transitory computer readable media such as an optical medium (e.g., CD-ROM), floppy or hard disk or other a medium such as firmware or microcode in one or more ROM or RAM or PROM chips, an Application Specific Integrated Circuit (ASIC), etc. The software or firmware or other such configurations can be installed onto a controller to cause the controller to perform the techniques explained herein.

Accordingly, one particular embodiment of the present disclosure is directed to a computer program product that includes a computer readable medium having instructions stored thereon for supporting operations such as controlling phases in a power supply. For example, in one embodiment, the instructions, when carried out by computer processor hardware, cause the computer processor hardware to: receive a first input value indicating a magnitude of an input voltage used by a power supply circuit to produce an output voltage to power a respective load; receive a second input value indicating a magnitude of the output voltage produced by the power supply circuit; and use the magnitude of the input voltage and the magnitude of the output voltage to emulate current flowing through an inductor of the power supply circuit, the emulated current flow representative of an actual current supplied by the inductor to the load.

The ordering of the steps has been added for clarity sake. These steps can be performed in any suitable order.

By way of a non-limiting example, the concepts as discussed herein can be applied to switching voltage regulators with a buck topology for application to low voltage processors, memory, digital ASICs, etc. The concept however is applicable to other topologies such as boost and buck-boost regulators.

It is to be understood that the system, method, apparatus, etc., as discussed herein can be embodied strictly as hardware, as a hybrid of software and hardware, or as software alone such as within a processor, or within an operating system or a within a software application. Example embodiments of the invention may be implemented within products and/or software applications such as those developed or manufactured by International Rectifier Corporation of El Segundo, Calif., USA.

Additionally, note that although each of the different features, techniques, configurations, etc., herein may be discussed in different places of this disclosure, it is intended, where appropriate, that each of the concepts can optionally be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

FIG. 1 is an example diagram of a power supply and corresponding emulator circuit according to embodiments herein.

FIG. 2 is an example diagram illustrating operations executed by an emulator circuit according to embodiments herein.

FIG. 3 is an example diagram illustrating tracking of an emulated current versus actual current according to embodiments herein.

FIG. 4 is an example diagram illustrating a ramp generator circuit according to embodiments herein.

FIG. 5 is an example diagram illustrating ramp compensation according to embodiments herein.

FIG. 6 example timing diagram illustrating use of an emulated current produced by an emulator circuit to control power supply circuitry according to embodiments herein.

FIG. 7 is an example diagram illustrating biasing of an emulated current value to reduce errors according to embodiments herein.

FIG. 8 is an example comparative diagram illustrating theoretical undershoot and overshoot of an output voltage during transit conditions according to embodiments herein.

FIG. 9 is an example diagram illustrating a computer architecture to execute emulator operations according to embodiments herein.

FIG. 10 is an example diagram of a flowchart illustrating current emulation and power supply control according to embodiments herein.

### DETAILED DESCRIPTION

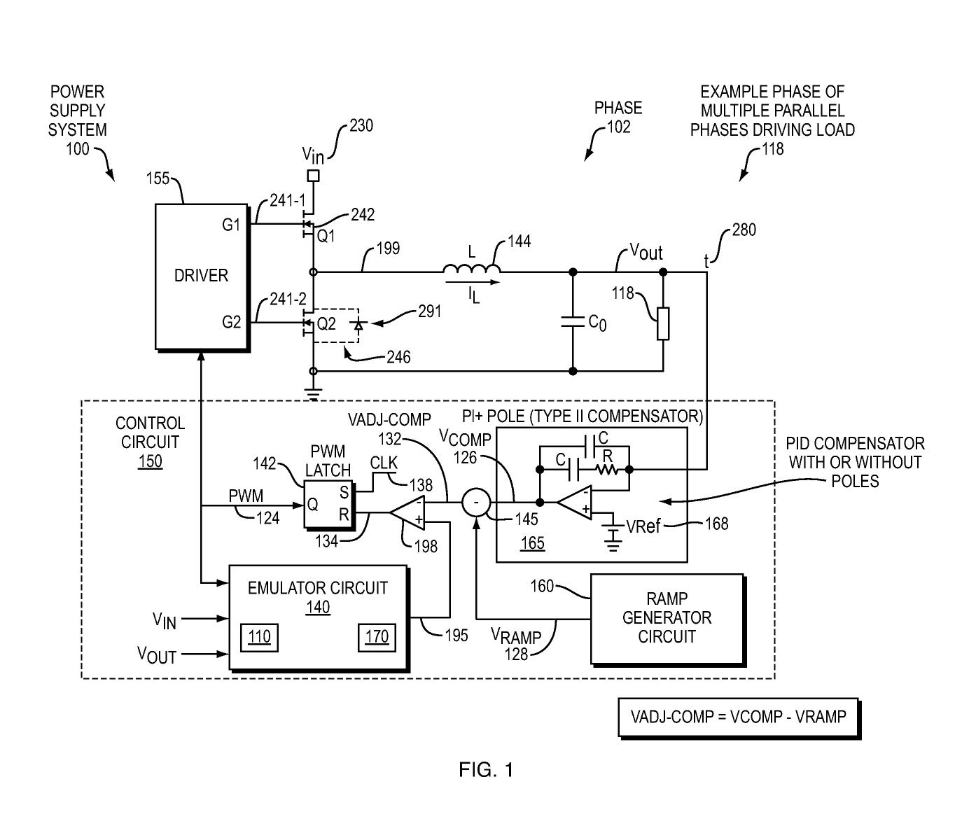

FIG. 1 is an example diagram of a power supply 100 according to embodiments herein. Note that any or all portions of the logical depiction of control circuit 150 shown in FIG. 1 can be implemented via analog and/or digital components.

As shown, the power supply 100 includes control circuit 150 (i.e., control circuitry). Controller circuit 150 controls operation of one of multiple phases (such as phase 102) in power supply system 100.

Note that the power supply system 100 can be configured to include any number of parallel phases. When activated, each phase supplies a corresponding amount of current to power dynamic load 118. Collectively, the sum of currents supplied by the phases power the dynamic load 118. The number of activated phases can vary over time depending on current consumption by dynamic load 118.

As further shown, phase 102 includes high side switch circuitry 242, low side switch circuitry 246, and inductor 144. Each of the other phases can include similar components. Phase 102 is a DC to DC converter.

During operation, the latch 142 of control circuit 150 produces PWM (Pulse Width Modulation) signal 124. The pulse width modulation signal 124 controls states of switch circuitry 242 and 246 to produce output voltage 280 within a desired DC (Direct Current) voltage range.

More specifically, an operator of the power supply system 100 can configure the power supply system 100 to produce the output voltage 280 to be a value such as 2.4 volt DC. In such an instance, the control circuit 150 controls the phases 150 to produce the output voltage 180 to be within a tolerable range around 2.4 volts DC.

Note that the value 2.4 VDC is shown by way of non-limiting example only and that an operator of power supply 100 can specify any suitable DC voltage in which to produce output voltage 280.

Further in this non-limiting example embodiment, the control circuit 150 includes emulator circuit 140. Emulator circuit 140 includes computer processing hardware 110 (such as arithmetic processing hardware) and buffer 170 (such as a multi-bit storage register). During operation, emulator circuit 140 receives feedback such as input voltage 230, output voltage 280, etc. The emulator circuit 140 produces signal 195 (a control signal representing an estimated amount of current through inductor 144 supplied to load 118). Control circuit 150 uses the signal 195 to control driver circuitry 155. The driver circuitry 155 controls operation of respective high side switch circuitry 242 and low side switch circuitry 246 based on the state of the pulse width modulation signal 124. Low side switch circuitry 246 includes inherent diode 291.

Note that the high side switch circuitry 242 and low side switch circuitry 246 each can include one or more switches such as MOSFET (Metal Oxide Semiconductor Field Effect Transistor) devices.

When the pulse width modulation signal 124 is set to a logic high state, the driver circuitry 155 produces control signal 241-1 to activate high side switch circuitry 242; drive circuitry 155 produces control signal 241-2 to deactivate low side switch circuitry 246. When high side switch circuitry 242 is activated or turned ON (while low side switch circuitry 246 is OFF), the high side switch circuitry 242 creates a highly conductive path from the input voltage 230 (Vin) to the input node 199 of inductor 144. In this instance, while the high side switch circuitry 242 is set to a respective ON state, via current supplied by the input voltage 230, the current through inductor 144 to load 118 increases.

Conversely, when the pulse width modulation signal 124 is set to a logic low state, the driver circuitry 155 produces control signal 241-1 to deactivate high side switch circuitry 242; drive circuitry 155 produces control signal 241-2 to activate low side switch circuitry 246. When low side switch circuitry 246 is activated or turned ON (while high side switch circuitry 242 is OFF), the low side switch circuitry 246 creates a highly conductive path from a ground reference to the input node 199 of inductor 144. In this instance, while the low side switch circuitry 246 is set to a respective ON state, via current to ground, the current through inductor 144 to load 118 decreases.

In one embodiment, to disable a phase, the phase control logic 240 can be configured to set both high side switch circuitry 142 and low side switch circuitry 146 to an OFF state such that the phase 102 is disabled and no longer provides current to dynamic load 118.

As its name suggests, the current consumption by dynamic load 118 may be the same or vary over time. By way of a non-limiting example, the dynamic load 118 may consume 2 amperes of current in a first time window and 100 amperes in subsequent millisecond time window. Thus, a change in current consumption can be drastic. At other times, the dynamic load 118 may consume a reasonably fixed amount of current such as 5 amperes for several seconds.

In this example embodiment, as previously discussed, control circuit 150 includes emulator circuit 140. Emulator circuit 140 includes computer processing hardware 110 and buffer 170. Emulator circuit 140 receives a first input value (such as an analog or digital value) indicating a magnitude of an input voltage 230 used by power supply system 100 to produce an output voltage 280 to power a respective load 118. Emulator circuit 140 also receives a second input value (such as an analog or digital value) indicating a magnitude of the output voltage 280.

The emulator circuit 140 uses the magnitude of the input voltage 230 and the magnitude of the output voltage 280 to emulate current flowing through inductor 144. The computer processing hardware 110 stores a value (such as an analog a digital value) in buffer 170 representing the emulated current flow. The emulated current flow is representative of an actual current, I_{L}, supplied by the inductor 144 to the load 118.

The emulator circuit 140 also receives the pulse width modulation signal 124. The computer processing hardware 110 of the emulator circuit 140 uses the pulse width modulation signal 124 to determine a state of high side switch circuitry 242 and low side switch circuitry 246.

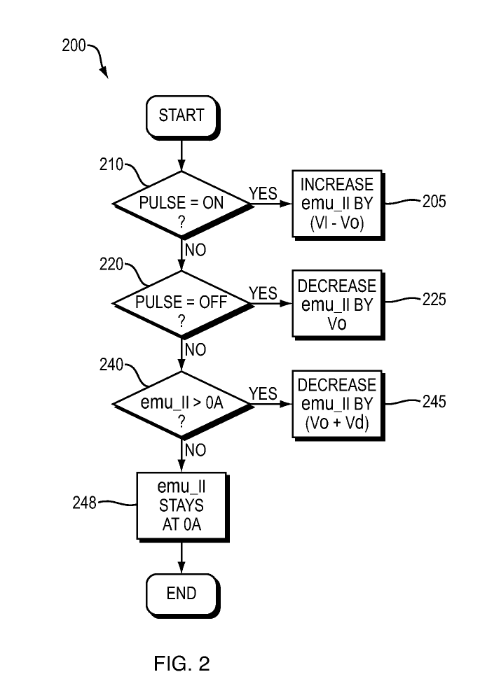

As an example, as further shown in FIG. 2, to emulate current flow, in step 210 of flowchart 200, the computer processing hardware 110 determines whether high side switch circuitry 242 is set to an ON state. If so, in step 205, the computer processing hardware 110 increments the value stored in the buffer 170 based on values of the input voltage 230 and the output voltage 280. Recall that the value stored in the buffer 170 represents an amount of current flowing through inductor 144 to the load 118.

If it is determined in step 210 that the high side switch circuitry 242 is not set to an ON state, flow continues to step 220. In step 220, the computer processing hardware 110 determines whether low side switch circuitry 246 is set to an ON state. If so, in step 225, the computer processing hardware 110 decrements the value stored in the buffer 170 based on a magnitude of the output voltage 280.

If it is determined in step 220 that the low side switch circuitry 246 is not set to an on state, flow continues to step 240. In step 240, while in the tri-state mode in which neither the high side switch circuitry 242 nor the low side switch circuitry 246 are activated, the computer processing hardware 110 checks whether the value (EMU_I_{L}) in buffer 170 is greater than 0 A. If so, the computer processing hardware 110 decrements the value in buffer 170 based on a magnitude of the output voltage 280 and an inherent diode 291 drop, V_{D}, associated with low side switch circuitry 246. For example, the computer processing hardware 110 decreases the value stored in buffer 170 by Vout+V_{D}.

In step 240, the value stored in buffer 170 indicates that current to the inductor 144 eventually settles to 0 Amps after both the high side switch circuitry 242 and low side switch circuitry 246 are deactivated for a sufficient amount of time.

Referring again to FIG. 1, the emulator circuit 140 outputs the value in buffer 170 as control signal 195. The control signal 195 is inputted to the positive terminal (+) of comparator 198.

Control circuit 150 further includes compensator circuit 165. In one embodiment, the compensator circuit 165 represents a portion of a PID controller. For example, the compensator circuit 165 can be configured to include a P-component and an I-component, but no D-component of a PID circuit. The compensator circuit 165 produces control signal 126 (VCOMP, which is a feedback signal the state varies depending upon a comparison of the output voltage 280 to a reference voltage, Vref).

In one embodiment, the feedback loop response of the proposed emulated peak current mode control circuitry includes a double pole (two poles) similar to a loop response of a voltage mode controller. In accordance with alternative embodiments, note that the compensator circuit 168 can include any number of poles such as zero poles, one pole, two poles, etc.

Similar to a voltage mode controller, the load transient response according to embodiments herein is faster than a conventional current mode controller. Additionally, the current emulator circuit 140 creates a higher mid frequency gain and a lower mid frequency phase drop, which makes the compensator design less complicated.

As further shown, summer 145 receives control signal 126 as well as ramp signal 128 produced by ramp generator circuit 160. Summer circuit 145 subtracts the ramp signal 128 from the control signal 126 to produce control signal 132 (VADJ-COMP). The summer circuit 140 outputs the control signal 132 into the negative terminal of comparator 198. Thus, the comparator 198 receives control signal 132 and control signal 195.

The comparator 198 produces control signal 134 based on a comparison of the control signal 195 and control signal 132. Even though a regular comparator is shown for illustration, this comparator is a digital comparator capable of outputs with fractional clock resolutions. The output of the comparator 198 is inputted to the reset input, R, of set-reset latch 142. The Set input (S) of the set-reset latch 142 receives clock 138 (such as 800 KHz clock signal or any other suitable value). Based on settings of the clock signal 138 and control signal 134, the set-reset latch 140 produces pulse width modulation signal 124 that is outputted to control drive circuitry 155 in a manner as previously discussed.

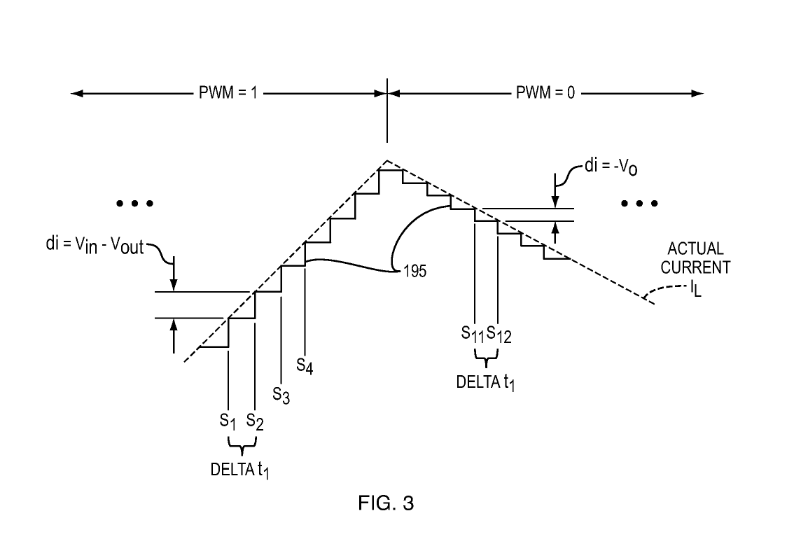

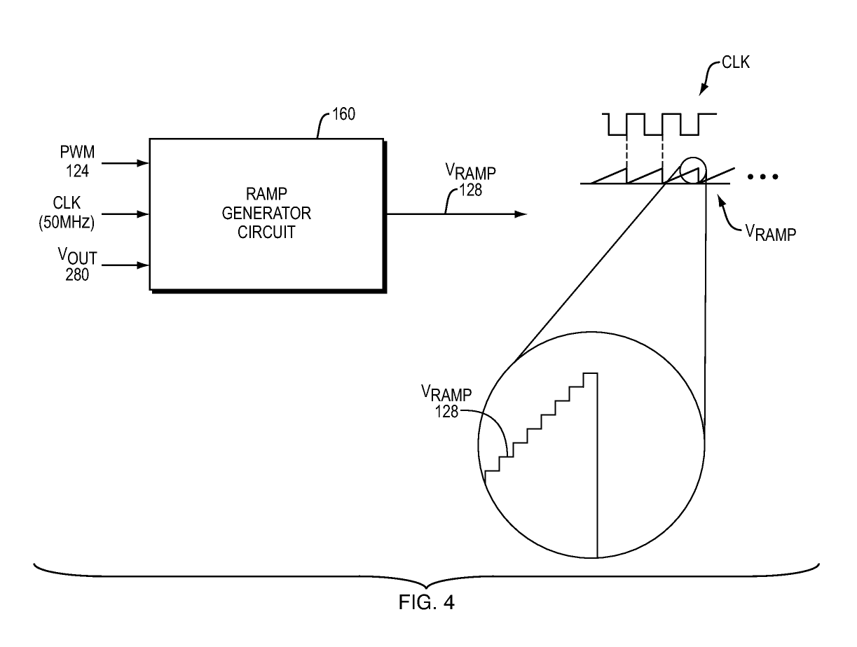

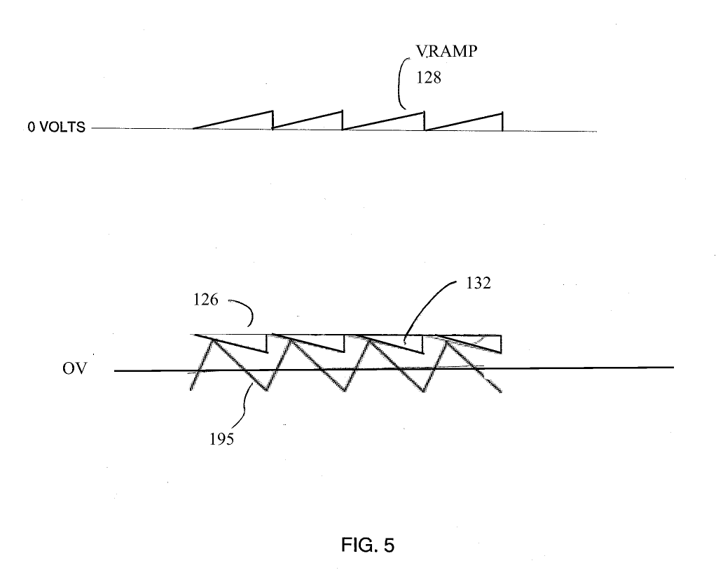

Additional details of generating control signal 195 are shown in FIG. 3. Additional details of generating the ramp signal 128 are shown in FIG. 4. Timing diagrams are shown in FIGS. 5-8.

FIG. 3 is an example diagram illustrating current flow emulation according to embodiments herein.

As shown, the emulator circuit 140 performs continuous sampling each sample time S1, S2, S3, etc. Delta t1 represents the time between samples. As previously discussed, depending upon the state of the pulse width modulation signal 124, the computer processing hardware 110 increments or decrements the value stored in buffer 170.

For example, during samples was when PWM is equal to a logic high (such as when the high side switch circuitry 242 is activated and the low side switch circuitry 246 is deactivated), the change in the inductor current 144 is di=Vin−Vout. Recall that the emulator circuit 140 receives inputs including input voltage 230 (Vin) and output voltage 280 (Vout). The computer processing hardware 110 adds the change in inductor current value, di (representing delta current for the corresponding sample), to the current value stored in a buffer 170.

During samples when PWM is equal to a logic low (such as when the low side switch circuitry 246 is activated and the high side switch circuitry 242 is deactivated), the change in current di=−Vout. Recall again that the emulator circuit 140 receives the output voltage 280. The computer processing hardware 110 adds the value, di (representing delta current for the corresponding sample), to the current value stored in a buffer 170. Because the changing current is negative, the computer processing harder 110 decrements the current count in buffer 170.

Accordingly, in this manner, the emulated current value stored in buffer 170 tracks the actual current, I_{L}, delivered through the inductor 144 to the load 118.

In one non-limiting example embodiment, the emulator circuit 140 performs a sample every 20 ns. However, any suitable sample time can be used. Further, if desired, the inductor 144 can be modeled as a 20 nH device substantially matching the inductance associated with the inductor 144. In such an instance, the value stored in buffer 170 need not be modified with a respective gain value. Instead, the value stored in the buffer 170 represents an emulated amount of current passing through inductor 144 to load 118.

Of course, the emulator circuit 140 can be configured to use different sampling times and inductor values to produce control signal 195. In such an instance, a gain can be applied to the value stored in buffer 170 to produce signal 195. Alternatively, the gain associated with the compensation circuit 165 can be adjusted to accommodate for variations.

### Inductor Current Emulation:

V=L*di/dt, thus di/dt=V/L. here L is the inductance of inductor 144, di/dt is the change in current for a sample time step, and V is the voltage across the inductor 144.

V=(Vi−Vo,PWM=1

−Vo,V=PWM=0

−Vo−Vd,PWM=tri-state)

dt=20 ns

L=20 nH

where: V=voltage across inductor 144, Vi=input voltage, Vo=output voltage, Vd=diode voltage.

FIG. 4 is an example diagram illustrating a ramp generator circuit according to embodiments herein.

As shown, ramp generator circuit 160 receives the clock signal (CLK such as a 50 MHz signal), PWM signal 124, and the output voltage 280. At the rising edge of the PWM signal 124, the Vramp signal 128 is reset to 0. Then, as previously discussed and further discussed below, the magnitude of the Vramp signal 128 increases (such as incremented each cycle of CLK, 50 MHZ) with a slope that is a function (such as a portion) of the output voltage, until the Vramp signal 128 it is reset to 0 again at the next rising edge of the PWM signal 124. In one non-limiting example embodiment, the ramp generator circuit 160 can include a buffer (such as a multi-bit register to store a Vramp signal 128 as a digital count value) and arithmetic processing hardware (such as computer processor hardware) in embodiments in which the Vramp signal 128 is digital in nature. As previously discussed, in accordance with alternative embodiments, any circuitry including the ramp generator circuit 160 can be an analog circuit.

As further shown in FIG. 5, the comparator 198 compares control signal 195 to control signal 132. The control signal 132 represents a threshold value. When the magnitude of the control signal 195 equals or exceeds the magnitude of the control signal 132 (or at a time when the magnitude of the control signal 195 is projected to equal or exceed the magnitude of the signal 132), the comparator 198 produces control signal 134 to reset the latch 142. In other words, the generated reset signal causes the set-reset latch 142 to change the output pulse width modulation signal 124 to a logic low state. Setting of the pulse width modulation signal 124 to the logic low state causes the driver circuitry 155 to shut off high side switch circuitry 242 and turn OFF low side switch circuitry 246. At such time, as previously discussed, the value stored in buffer 170 decreases as shown by control signal 195.

In one embodiment, the comparator 198 and corresponding signals 132 and 195 are digital. As mentioned above, the comparator 198 (such as a digital circuit) basically compares the signals 132 and 195 and terminates PWM signal 124 (to a zero state, turning OFF the respective high side switch circuitry) when signal 195 crosses (or is projected to cross) signal 132. Thus, the combination of comparator 198 and latch 142 can be purely digital to perform the functions as described herein.

In accordance with further embodiments, the pulse termination of the PWM signal 124 can be configured to have a high time resolution (such as greater than 100 MHz), in which pulses are terminated on fractions of a clock cycle (CLOCK, such as 50 MHz) used to increment a magnitude of the Vramp signal 128. More specifically, the control circuit 150 can include computer processing hardware to project (using interpolation and/or extrapolation) into the future a precise time when the signal 195 will cross (become greater than or equal to) a magnitude of the signal 132. In accordance with the projected crossing, which is determined based on the slope of the signal 195 and the slope of the signal 132 and the specific time in which they are expected to intersect, the computer processing hardware associated with control circuit 150 initiates resetting of the latch 142 at such at or around the projected time of crossing as opposed to actually waiting for the signal 195 to be greater than signal 132 on subsequent sample clock cycles. This technique of extrapolating provides a precise control of deactivating a respective high side switch (via setting PWM signal 124 low). Accordingly, the resolution of the clocks used to generate any of the signals such as signal 132, signal 195, etc., do not negatively impact control of the respective phase.

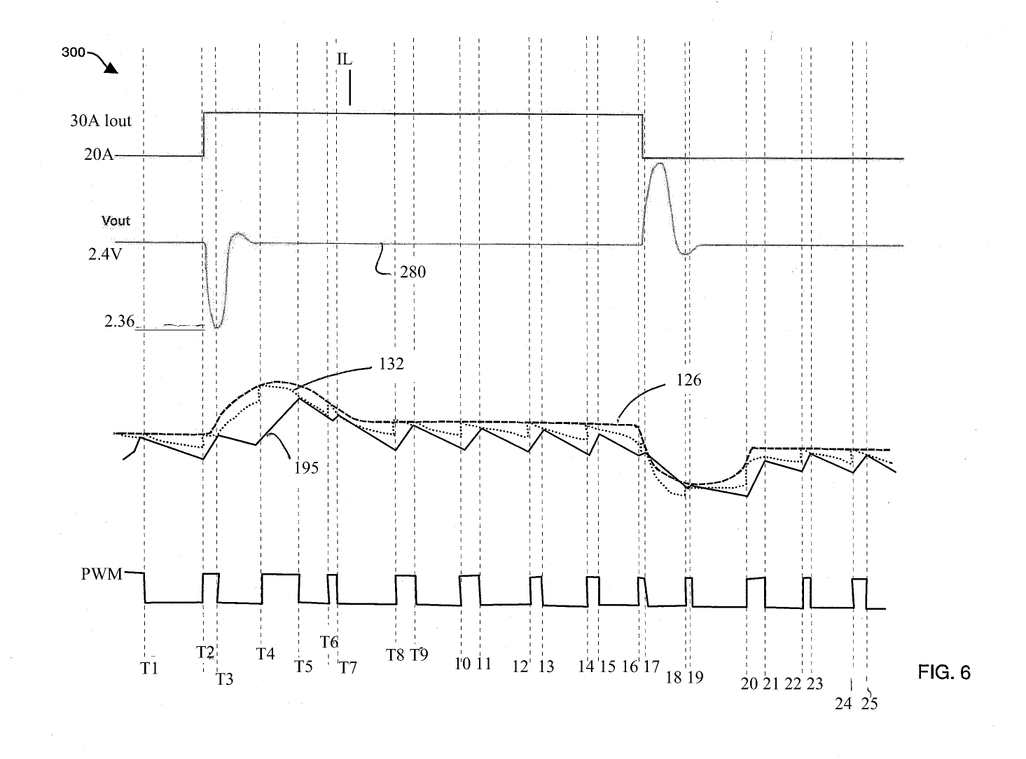

On the subsequent rising edge of clock 138 (such as an 800 kHz clock), the set-reset latch 142 switches the pulse width modulation signal 124 to a logic high state again. This logic high state causes the drive circuitry 155 to activate high side switch circuitry 242 and deactivate low side switch circuitry 246, increasing the amount of current through the inductor 144 again. This is more particularly shown in FIG. 6.

FIG. 6 is an example timing diagram illustrating current mode control according to embodiments herein.

In this example embodiment, prior to time T3, the control circuit 150 maintains the output voltage 280 at a steady state of around 2.4 V DC. Prior to time T2, the load 118 consumes 20 A. At time T2, the load 118 instantaneously consumes 30 A, representing 10 A of additional current consumption. The output voltage 280 initially drops as a result of the increased current consumption by the load 118.

More specifically, at time T1, comparator 198 detects that the control signal 195 is equal to or greater than the control signal 132. As a result, the output signal 134 from comparator 198 causes the latch 142 to reset the pulse width modulation signal 124 to logic zero deactivating the high side switch circuitry 242. As previously discussed, between time T1 and T2, the low side switch circuitry 246 is activated.

At or around time T2, the positive edge of clock 138 causes the latch 142 to switch to a logic high again (pulse width modulation signal 124 is set to logic high state). At such time, the current through the inductor 144 increases as indicated by control signal 195 as a result of activating the high side switch circuitry 242.

Eventually, at following time T3, the comparator 198 detects that the magnitude of the control signal 195 is equal to or greater than a magnitude of the control signal 132 again. At such time T3, the comparator 198 produces control signal 134 to reset the latch 142. Resetting of the latch 142 causes the pulse width modulation signal 124 to reset to a logic low. This causes the driver circuitry 155 to shut off high side switch circuitry 242 and turn ON low side switch circuitry 246.

After reaching a steady state between time T8 and T16, a load release transient occurs after time T16. At such time, the load 118 instantaneously consumes less current. The control circuitry 150 operates to achieve a steady state again based on a comparison of the control signal 195 and control signal 132.

In this manner, for each of the following cycles, the current mode control circuitry (control circuit 150) disposed in power supply system 100 regulates the output voltage 280 to be within a desired voltage range.

Further, note that the techniques as discussed herein are applicable to any type of current mode control such as peak current mode, valley current mode, hysteretic mode, dual edge mode, etc.

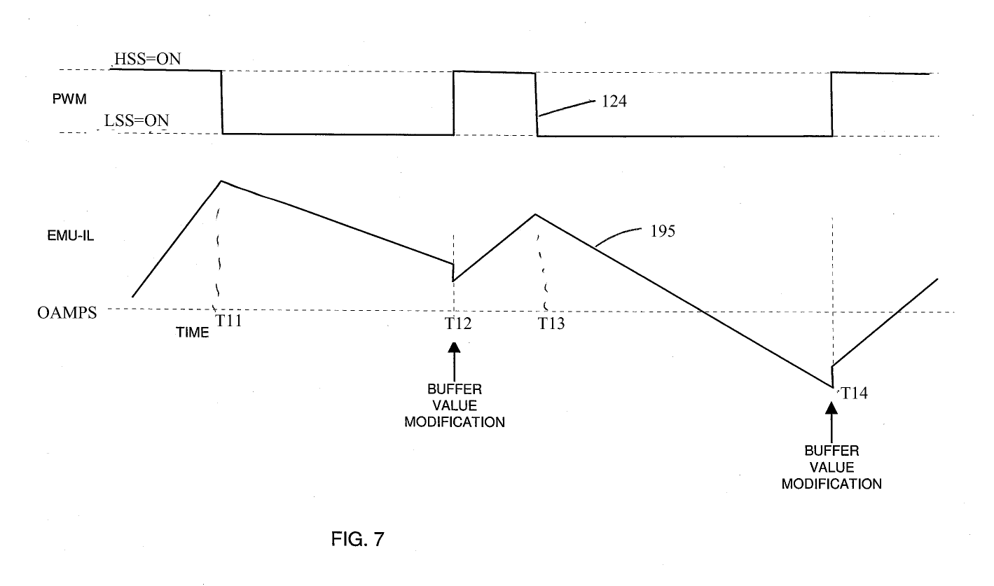

FIG. 7 is an example diagram illustrating modification of an emulated current value according to embodiments herein.

In this example embodiment, the value of the emulated current stored in buffer 170 is modified (biased towards zero amperes) at periodic times such as between a transition of deactivating the low side switch circuitry 246 and activating the high side switch circuitry 242.

By way of one non-limiting example embodiment, the emulator circuit 140 can be configured to reduce a magnitude of the control signal 195 (emulated current flow EMU-I_{L}) by 25% towards 0 Amps. More specifically, at time T71, the computer processing hardware 110 reduces a magnitude of the value stored in buffer 170 by an amount such as 25% of the total magnitude. Additionally, at time T72, the computer processing hardware 110 reduces a magnitude of the value (representing negative current) stored in buffer 170 by an amount such as 25% of the total magnitude.

In accordance with further embodiments, to ensure that emu_I_{L} (value stored in buffer 170) is not affected by Vin and/or Vout inaccuracies, the control circuit 150 can be configured to periodically ‘correct’ emu_I_{L} by subtracting either k*emu_I_{L}, or k*Vcomp, where k is a constant. The period can be anywhere from the regulator switching frequency to every 50 MHz clock cycle. This results in an AC signal 195, useful for control purposes. In other words, periodically or occasionally reducing the magnitude of the value stored in buffer 170 prevents errors from accumulating over time, ensuring that the value stored in buffer 170 is a good representation of the AC current through inductor 144 delivered to the load 118.

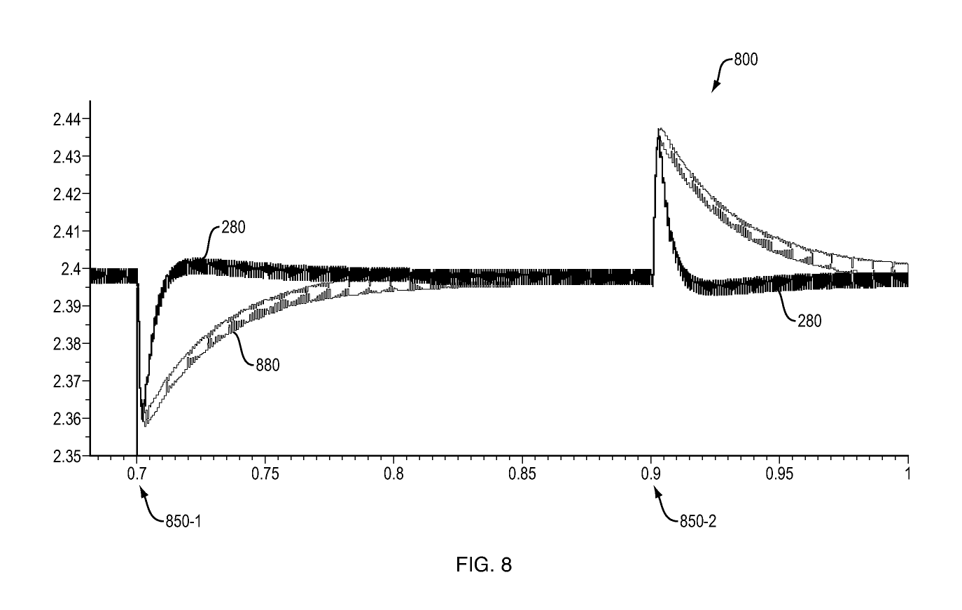

FIG. 8 is an example diagram illustrating theoretical undershoot and overshoot of an output voltage during transit conditions according to embodiments herein.

Graph 800 illustrates that a transient condition 850-1 (of consuming an instantaneous increase in current by load 118) causes an undershoot output voltage condition. For comparison purposes, graph 800 indicates how a conventional current mode control circuit would produce output voltage 880, which takes much longer to achieve a steady-state condition after occurrence of the transient condition 850-2 than does control circuit 150 which produces output voltage 280.

Graph 800 further illustrates that a transient condition 850-2 (of consuming an instantaneous decrease in current by load 118) causes an overshoot condition on the respective output voltage 280. For comparison purposes, graph 800 indicates how a conventional current mode control circuit would produce output voltage 880, which takes much longer to achieve a steady-state condition after the transient condition 850-2 than control circuit 150.

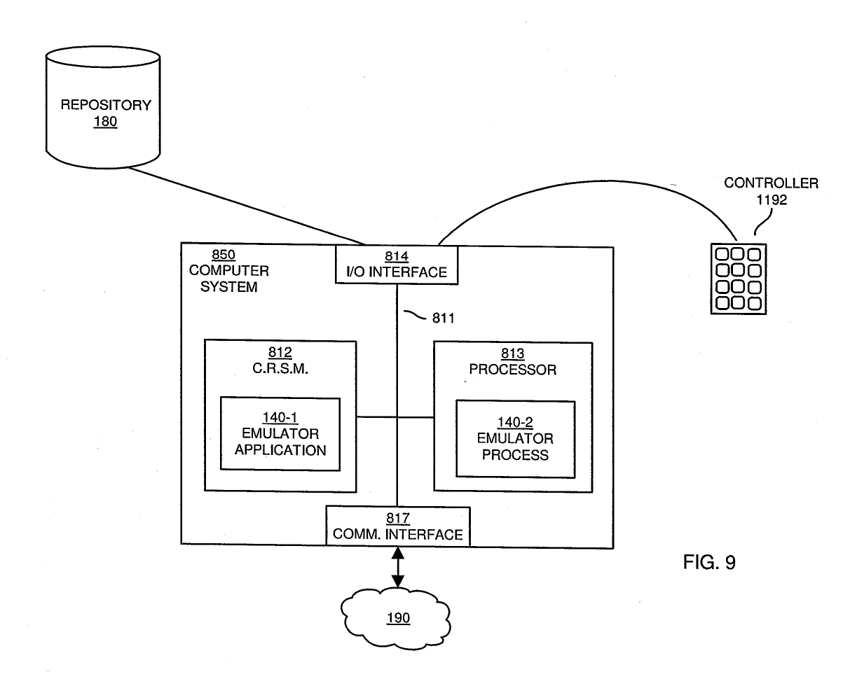

FIG. 9 is a diagram illustrating an example computer architecture in which to execute any of the functionality according to embodiments herein. Any of the different processing operations as executed by control circuit 150, the emulator circuit 140, the power supply system 100, etc., can be implemented via execution of software code on a computer system.

For example, as shown, computer system 850 (e.g., such as computer processor hardware) of the present example can include an interconnect 811 that couples computer readable storage media 812 such as a non-transitory type of media (i.e., any type of hardware storage medium) in which digital information can be stored and retrieved. The computer system 850 can further include processor resource 813 (i.e., computer processor hardware such as one or more co-located or disparately located processor devices), I/O interface 814, communications interface 817, etc.

Computer processor hardware (i.e., processor 813) can be located in a single location or can be distributed amongst multiple locations.

As its name suggests, I/O interface 814 provides connectivity to external resources such as storage devices (such as storage device 180), control devices (such as input resource 1192), one or more display screens, etc.

Computer readable storage medium 812 can be any hardware storage device to store data such as memory, optical storage, hard drive, floppy disk, etc. In one embodiment, the computer readable storage medium 812 stores instructions and/or data.

Communications interface 817 enables the computer system 850 and processor resource 813 to communicate over a resource such as any of networks 190, shared communication link 191, etc. I/O interface 814 enables processor resource 813 to access data from a local or remote location, control a respective display screen, receive input, etc.

As shown, computer readable storage media 812 can be encoded with emulator application 140-1 (e.g., software, firmware, etc.) executed by processor resource 813. Emulator application 140-1 can be configured to include instructions to implement any of the operations as discussed herein.

During operation of one embodiment, processor resource 813 accesses computer readable storage media 812 via the use of interconnect 811 in order to launch, run, execute, interpret or otherwise perform the instructions in emulator application 140-1 stored on computer readable storage medium 812.

Execution of the emulator application 140-1 produces processing functionality such as emulator process 140-2 in processor resource 813. In other words, the emulator process 140-2 associated with processor resource 813 represents one or more aspects of executing emulator application 140-1 within or upon the processor resource 813 in the computer system 850.

Those skilled in the art will understand that the computer system 850 can include other processes and/or software and hardware components, such as an operating system that controls wireless connectivity in network environment 100.

In accordance with different embodiments, note that computer system may be any of various types of devices, including, but not limited to, a set-top box, access point, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, etc., or in general any type of computing or electronic device.

The computer system 850 may reside at any location or multiple locations in network environment 100. The computer system 850 can be included in any suitable resource in network environment 100 to implement functionality as discussed herein.

Note that each of the other functions as discussed herein can be executed in a respective computer system based on execution of corresponding instructions.

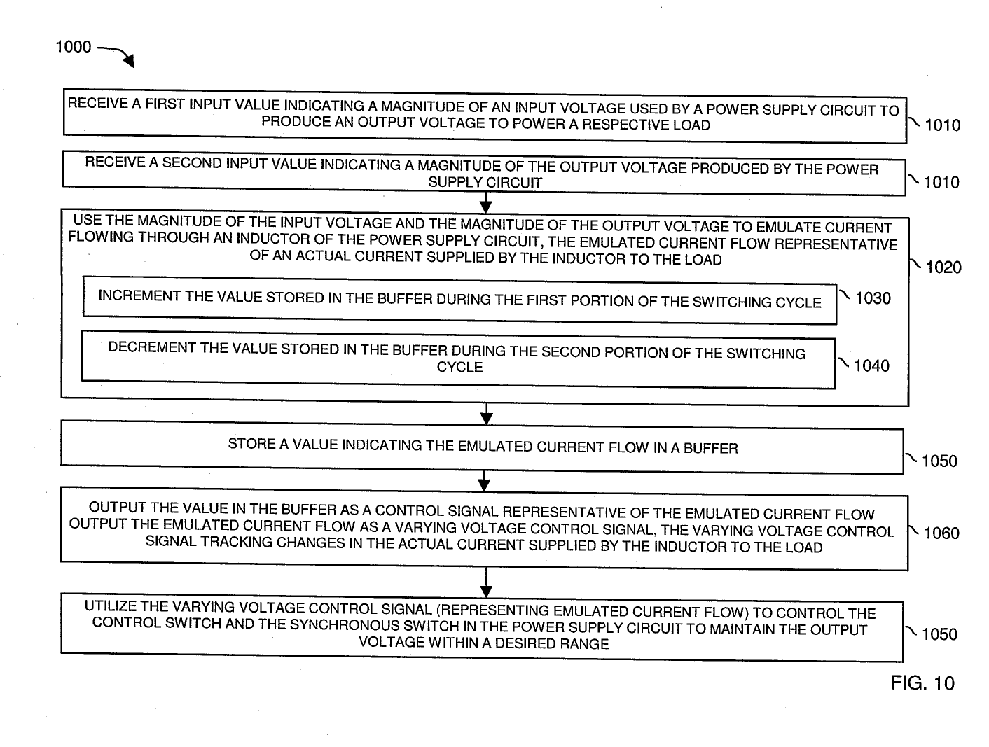

FIG. 10 is a flowchart 1000 illustrating an example method of controlling operation of a power supply system 100 according to embodiments herein. Note that there will be some overlap with respect to concepts as discussed above. Also, the steps can be executed in any suitable order.

In processing block 1010, the emulator circuit 140 receives a first input value indicating a magnitude of input voltage 230 (Vin). The power supply control circuit 150 uses the input voltage 230 to produce an output voltage 280 (Vout) to power a respective load 118.

In processing block 1020, the emulator circuit 140 receives a second input value indicating a magnitude of the output voltage 280 (Vout).

In processing block 1030, the emulator circuit 140 uses the magnitude of the input voltage 230 and the magnitude of the output voltage 280 to emulate current flowing through inductor 144 of the power supply system 100. In one embodiment, the emulated current value generated by the emulator circuit 140 is an estimate of an actual current supplied by the inductor 144 to the load 118.

In sub-processing block 1030, the emulator circuit 140 increments the value stored in the buffer 170 during the first portion of the respective switching cycle when the high side switch circuitry 242 is set to an ON state while low side switch circuitry 246 is set to an OFF state.

In sub-processing block 1030, the emulator circuit 140 decrements the value stored in the buffer 170 during the second portion of the switching cycle when the high side switch circuitry 242 is set to an OFF state while low side switch circuitry 246 is set to an ON state.

In processing block 1060, the emulator circuit 140 stores a value indicating the emulated current flow in a buffer 170.

In processing block 1070, the emulator circuit 140 outputs the value in the buffer 170 as a control signal 195 representative of the emulated current flow output. The outputted emulated current 195 tracks changes in the actual current supplied by the inductor 144 to the load 118.

In processing block 1080, the emulator circuit 150 utilizes the emulated current to control the control switch (high side switch circuitry 242) and the synchronous switch (low side switch circuitry 246) in the power supply system 100 to maintain the output voltage 118 within a desired range.

Note again that techniques herein are well suited for use in power supply circuitry operating in a current control mode in which an amount of current through the inductor 144 dictates control of high side switch circuitry 242 and low side switch circuitry 246. However, it should be noted that embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. An apparatus comprising:
an emulator circuit, the emulator circuit including: i) a first input to receive a first input value, the first input value indicating a magnitude of an input voltage used by a power supply circuit to produce an output voltage to power a respective load, ii) a second input to receive a second input value, the second input value indicating a magnitude of the output voltage produced by the power supply circuit; and
the current emulator circuit using the magnitude of the input voltage and the magnitude of the output voltage to emulate current flowing through an inductor of the power supply circuit, the emulated current flow representing an actual current supplied by the inductor to the load.

2. The apparatus as in claim 1, wherein the emulator circuit outputs the emulated current flow, the emulated current tracking changes in the actual current supplied by the inductor to the load.

3. The apparatus as in claim 2, wherein the power supply circuit includes a control switch and a synchronous switch electrically coupled to an input node of the inductor, an output node of the inductor producing the output voltage, the apparatus further comprising:
a control circuit configured to receive the emulated current, the control circuit utilizing the emulated current to control the control switch and the synchronous switch in the power supply circuit to produce the output voltage within a desired range.

4. The apparatus as in claim 3, wherein the control circuit receives a feedback signal generated based on comparison of the magnitude of the output voltage to a reference voltage, the control circuit comparing the feedback signal to the emulated current to control the control switch and the synchronous switch.

5. The apparatus as in claim 1, wherein the emulated current flow represents an AC (Alternating Current) portion of the actual current supplied by the inductor to the load.

6. The apparatus as in claim 1, wherein the current emulator circuit includes a buffer, the buffer storing a value indicating the emulated current flow, the current emulator circuit outputting a control signal representative of the emulated current flow.

7. The apparatus as in claim 6, wherein the power supply circuit includes a first switch circuit and a second switch circuit coupled to the inductor, the first switch circuit controlled to selectively couple the input voltage to a node of the inductor during a first portion of a switching cycle, the second switch circuit controlled to selectively couple the node of the inductor to a reference voltage during a second portion of the switching cycle; and
wherein the current emulator circuit further includes arithmetic processing hardware, the arithmetic processing hardware incrementing the value stored in the buffer during the first portion of the switching cycle, the arithmetic processing hardware decrementing the value stored in the buffer during the second portion of the switching cycle.

8. The apparatus as in claim 7, wherein the emulator circuit further includes a third input, the third input receiving a pulse width modulation control signal used to control activation of the first switch circuit and the switch second switch circuit during the switching cycle, the pulse width modulation control signal indicating the first portion of the switching cycle and the second portion of the switching cycle.

9. The apparatus as in claim 8, wherein the arithmetic processor hardware applies a bias to a magnitude of the value in the buffer, the application of the bias reducing the magnitude of the value towards a predetermined voltage value.

10. The apparatus as in claim 1 further comprising:
a control circuit, the current mode control circuit including a P-component and an I-component but no D-component of a PID circuit, the current mode control circuit generating a feedback signal; and
a digital comparator circuit configured to receive a signal representing the emulated current flow and the feedback signal generated by the control circuit, the comparator circuit producing a control signal indicating to modify the pulse width modulation signal in response to detecting that a value of the signal representing the emulated current flow crosses the feedback signal.

11. A method comprising:
receiving a first input value indicating a magnitude of an input voltage used by a power supply circuit to produce an output voltage to power a respective load;
receiving a second input value indicating a magnitude of the output voltage produced by the power supply circuit; and
using the magnitude of the input voltage and the magnitude of the output voltage to emulate current flowing through an inductor of the power supply circuit, the emulated current flow representative of an actual current supplied by the inductor to the load.

12. The method as in claim 11 further comprising:
outputting the emulated current, the emulated current tracking changes in the actual current supplied by the inductor to the load.

13. The method as in claim 12 further comprising:
controlling activation of a control switch and a synchronous switch electrically coupled to an input node of the inductor, an output node of the inductor producing the output voltage;
receiving the emulated current; and
utilizing the emulated current to control the control switch and the synchronous switch in the power supply circuit to maintain the output voltage within a desired range.

14. The method as in claim 13 further comprising:
receiving a feedback signal generated based on comparison of the magnitude of the output voltage to a reference voltage; and
comparing the feedback signal to the emulated current to control the control switch and the synchronous switch.

15. The method as in claim 11, wherein the emulated current flow represents an AC (Alternating Current) portion of the actual current supplied by the inductor to the load.

16. The method as in claim 11 further comprising:
storing a value indicating the emulated current flow in a buffer;
outputting the value in the buffer is a control signal representative of the emulated current flow.

17. The method as in claim 16, wherein the power supply circuit includes a first switch circuit and a second switch circuit coupled to the inductor, the method further comprising:
controlling the first switch circuit to selectively couple the input voltage to a node of the inductor during a first portion of a switching cycle; and
controlling the second switch circuit to selectively couple the node of the inductor to a reference voltage during a second portion of the switching cycle.

18. The method as in claim 17 further comprising:
incrementing the value stored in the buffer during the first portion of the switching cycle; and
decrementing the value stored in the buffer during the second portion of the switching cycle.

19. The method as in claim 18 further comprising:
receiving a pulse width modulation control signal used to control activation of the first switch circuit and the switch second switch circuit during the switching cycle;
utilizing the pulse width modulation control signal to identify the first portion of the switching cycle and the second portion of the switching cycle.

20. The method as in claim 19 further comprising:
applying a bias to a magnitude of the value in the buffer, the application of the bias reducing the magnitude of the value towards a predetermined voltage value.

21. The method as in claim 11 further comprising:
receiving a voltage signal representing the emulated current flow;
receiving a feedback signal generated by a compensation circuit;
comparing the voltage signal representing the emulated current flow and the feedback signal to produce a control signal, the control signal indicating to modify the pulse width modulation signal in response to detecting that a magnitude of the voltage signal representing the emulated current flow crosses the feedback signal.

22. Computer-readable storage hardware having instructions stored thereon, the instructions, when carried out by computer processor hardware, causing the computer processor hardware to perform operations of:
receiving a first input value indicating a magnitude of an input voltage used by a power supply circuit to produce an output voltage to power a respective load;
receiving a second input value indicating a magnitude of the output voltage produced by the power supply circuit; and
using the magnitude of the input voltage and the magnitude of the output voltage to emulate current flowing through an inductor of the power supply circuit, the emulated current flow representative of an actual current supplied by the inductor to the load.
